(19) United States
(12) Patent Application Publication
(10) Pub. No.: US 2007/0206786 A1
(43) Pub. Date: Sep. 6, 2007

(54) RFID SECURITY SYSTEM

(75) Inventor: Sayan Chakraborty, Niwot, CO (US)

Correspondence Address: Attn: Curtis A. Vock;Lathrop & Gage L.C., 4845 Pearl East Circle, Suite 300, Boulder, CO, 80301, US

(73) Assignee: Skyetek, Inc., Bolder, CO (US)

(21) Appl. No.: 11/306,980

(22) Filed: Jan. 18, 2006

Related U.S. Application Data
(60) Provisional application No. 60/712,957, filed on Aug. 31, 2005.

(51) Int. Cl. H04L 9/30

(52) U.S. Cl. 380/30

(57) ABSTRACT

A process for handling secret data. In an RFID tag, a cryptography key protecting the secret data is written while with a first holder, a threshold cryptography share is stored, or an arbitrary value is obtained for an identity-based encryption (IBE) algorithm. The cryptography key can then be read and used by a second holder to access the secret data, the threshold cryptography shares can be read and aggregated with other shares to access the secret data, or the arbitrary value can be used as the basis for a public key to protect the secret data and with a corresponding private key to access the secret data.

### RELATED APPLICATION

This application claims priority to provisional patent application Ser. No. 60/712,957, filed Aug. 31, 2005, the disclosures of which is incorporated herein by reference.

### BACKGROUND ART

Although originally rooted largely in linguistics, cryptography today primarily employs mathematical techniques to secure information. Encryption is one such technique, being the process of converting ordinary information into an unreadable form, and decryption is a reverse technique, being the process of converting the information in unreadable form back into readable form.

In some cryptographic systems (cryptosystems), knowledge of a decryption algorithm is all that is needed to convert unreadable information back into readable form. The decryption algorithm here can be, but is not necessarily, the same as the encryption algorithm.

In other cryptosystems the algorithm or algorithms used are controlled by keys, pieces of information that enable the encryption and decryption processes. It is increasingly common today for a key of one cryptosystem to be the very data being secured by another cryptosystem.

Historically, cryptosystems have used the same keys for both encryption and decryption. These are termed symmetric key systems. Increasingly today, however, asymmetric key systems are employed, wherein different keys are used for encryption and decryption.

Public-Key Infrastructure (PKI) cryptosystems are an example of an asymmetric key system. Unlike a symmetric key cryptosystems, where a key is desirably a closely kept secret, PKI systems usually employ both a publicly available key and a privately held key. Furthermore, since the keys used by most PKI systems today are larger than humans can conveniently memorize or directly work with, PKI keys are often stored, distributed, and managed using other cryptosystems.

Preparing wireless devices (such as a 802.11 equipped laptop computer) for operation is a common example where a secure mechanism for key exchange is sorely needed. These must first either have their wireless security configured while connected to a wired network or a laborious and error-prone mechanism such as manual human entry of long security keys must be employed. This is necessary to guarantee the secure transfer of the encryption/decryption keys from one device (such as the network) to the other (such as the laptop), since the mechanism ultimately being secured (the wireless connection) cannot itself be trusted. As such devices proliferate, the difficulties and costs associated with either once-used wired connections or hand-entry of keys (especially in devices with only a wireless interface and no display) will increase unless an efficient alternative to the traditional schemes is adopted.

Accordingly, one thing that is needed is a secure and efficient mechanism for cryptosystem key exchange.

In cryptography, secret data may be converted into a plurality of shares, wherein the secret data may not be determined by inspection of a single share. A secret data sharing scheme is one that permits shares to be allocated amongst, and distributed to, a group of shareholders. The secret data can then only be reconstructed when the shares are combined together, with the individual shares on their own simply being of no use to one wishing to know the secret data. [See e.g., Adi Shamir, “How to Share a Secret,” Communications of the ACM, Volume 22 Issue 11 (November 1979). Secret data sharing schemes where all of the shares are required to the determine the secret data are particularly useful for the protection of single-use data.

A threshold secret data sharing scheme can be built on the above principle, and is one that permits the secret data to be reconstructed with all or less than all of the shares (i.e., a threshold quantity). [An overview of the applications and techniques associated with threshold cryptography is provided in: Peter Gemmell, “An Introduction to Threshold Cryptography,” Cryptobytes—the Technical Newsletter of RSA Laboratories, Winter 1997; and in: Bruce Schneier, Applied Cryptography, 2nd Edition, Wiley and Sons, 1996, pp. 71-73 and 528-531. Threshold secret data sharing schemes are particularly useful for the protection of multi-use data.

Briefly, in threshold cryptography secret data, s, is converted into n shares and distributed among secret data shareholders in such a way that the secret data's secrecy is preserved while also meeting data integrity and availability goals. A general k-of-n type threshold protocol requires that a k subset (the threshold) of the n shares of s be reassembled to reveal the secret data (k can be n, of course), but that assembly of k-1 components does not yield useful information about s. This allows protection from exposure, loss, or alteration of some components of n (up to n-k components) without exposing s, or preventing s from being reassembled when needed.

In Shamir's original protocol, a polynomial, p, of degree k-1 is created with all coefficients (aᵢ) random, except that p(0)=aₒ=s. Each shareholder is sent a value of p computed at some non-zero point. To reassemble s, only k shareholders need provide their points and perform a LaGrange interpolation. Delivery of multiple shares to a given shareholder is possible, and is one of several techniques for allowing some shareholders to have greater weight than others.

Some examples of real-world applications for threshold cryptography include authorizing large financial transactions or missile launch orders. In both of these cases, splitting up the authorization code using threshold techniques protects inadvertent or adversarial use by both internal and external actors while also preserving the ability to use the code when needed. Applications such as these are similar in principle to others where traditional techniques have long been used, such as requiring simultaneous physical actions (e.g., opening a safety deposit box with two keys), requiring multiple signatures, or requiring multiple forms of identification to allow certain transactions.

In theory, threshold techniques offer the ability to translate many traditional applications to the electronic world with equivalent security and robustness, as well as the ability to enable new applications and to perform them efficiently, securely, and robustly. Unfortunately however, threshold techniques are not widely used presently due to logistical problems. For instance, how and where would shares be stored such that they are secure and accessible? And how would they then be reassembled?

Accordingly, another thing that is needed is a secure and efficient mechanism for threshold cryptosystem share handling.

Identity-Based Encryption (IBE) was also first introduced by Shamir, in 1984. [See e.g., Adi Shamir, “Identity-Based Cryptosystems and Signature Schemes,” Proceedings of Crypto '84, pp. 47-53. While quite promising, however, the original approaches from 1984-2001 were too computationally intensive, too insecure to collusion, or both. In 2001, Professor Dan Boneh of Stanford University provided practical functional algorithms for the implementation of IBE. [An overview is provided in: Martin Gagne, “Identity-Based Encryption: a Survey,” Cryptobytes—the Technical Newsletter of RSA Laboratories, Spring 2003.

Briefly, in IBE an arbitrary string takes the place of the public key found in a standard PKI cryptosystem. The arbitrary string is usually closely associated with a particular person, which we can call the principal user. For instance, a typical such string can be an email address or telephone number of the principal user. Since the arbitrary string can often be determined easily, any party can usually generate a public key from it. To do this, a trusted third party, called the Private Key Generator (PKG) publishes a “master” public key, while retaining the corresponding master private key. With the master public key and the arbitrary string of a principal user any party can then compute a public key corresponding to that principal user. The PKG similarly uses its master private key to generate the private key (which is why the PKG particularly must be trusted and employ suitable authentication measures before releasing it to a party purporting to be the principal user).

IBE has three major advantages over standard PKI. First, the use of an already well-known arbitrary string for the public key allows the elimination of much of the required directory and certificate management infrastructure. Second, it allows the use of ephemeral public keys. And third, it allows the concatenation of the string with other strings (such as one specifying a time) to create ‘custom’ public keys (e.g., one good until the time specified in the concatenated string).

Nonetheless, traditional IBE also has some of the inherent problems of PKI, such as key management. As noted in passing above, the keys used by most PKI systems today are larger than humans can conveniently memorize or directly work with. The use of an arbitrary string as the basis for a public key helps but does not eliminate the burden of key management in IBE cryptosystems, since PKI keys are still ultimately used.

Accordingly, yet another thing that is needed is a secure and efficient mechanism for IBE cryptosystem key management.

### SUMMARY

The present systems and methods provide a secure and efficient mechanism for handling secret data especially, but not necessarily, where the secret data itself includes a general cryptosystem key, an identity-based encryption (IBE) cryptosystem key, or one or more threshold cryptosystem shares.

In an embodiment, a process for handling a secret data includes writing a cryptography key in a data storage area in a radio-frequency identification (RFID) tag while the RFID tag is associated with a first holder. The cryptography key is read from the RFID tag while the RFID tag is associated with a second holder. At least one of the steps of encrypting, decrypting, signing, signature verifying, and integrity checking are performed on the secret data based on said cryptography key.

In an embodiment, process for handling secret data includes creating n shares of the secret data using a threshold cryptography algorithm such that only reconstruction of at least k of the shares reveals the secret data and wherein 1<k≧n. At least one share is stored in a RFID tag.

In an embodiment, a process for handling secret data includes obtaining, in a RFID tag, an arbitrary value for an identity-based encryption (IBE) algorithm. The arbitrary value is read from the RFID tag. A public key is determined from the arbitrary value, wherein the public key has a corresponding private key.

### BRIEF DESCRIPTION OF THE DRAWINGS

FIG. 1a-b are block diagrams depicting the exemplary elements of a RFID security system, according to an embodiment.

FIG. 2 is a flow chart depicting an exemplarly threshold cryptography share handling process, according to an embodiment.

FIG. 3 is a schematic depicting an exemplary identity-based encryption (IBE) scenario, according to an embodiment.

In the various figures of the drawings, like references are used to denote like or similar elements or steps.

### General Key Exchange and RFID

RFID tags can be used as a general, inexpensive, transportable, but secure storage for the exchange of keys to be used for encryption and decryption, for signing and verification, and for integrity checks. RFID tags can be manufactured so that they are secure, tamper-proof, and employ write-once, read-many (WORM) memory for part or all of their data storage capability.

RFID tags (also sometimes referred to as transponders) are cheap and becoming cheaper and the same holds true for RFID reading and writing devices (frequently referred to as simply RFID readers, even when used for either or both functions, and also sometimes referred to as interrogators). As of this writing, RFID tags are less than US $0.10 and RFID readers are roughly US $50.00 from some vendors. The cost savings are even more compelling if an existing wireless radio (ZigBee, Wireless USB, 802.11a/b/g/n) can also be used for RFID purposes, using low power levels.

The secure key can be written to an RFID tag by one RFID reader, and transported to the field of another RFID reader where it can be read. The second RFID reader can then erase the RFID tag and/or it can be physically destroyed after use.

In an alternative scenario, the RFID readers themselves can communicate with each other (if in physical proximity) using their readers in near-field communications (NFC) mode, a variant of RFID for device to device communications. In this case an RFID tag need not be used at all. For this reason the term RFID device is used generically herein to mean an RFID tag or an RFID reader used in NFC mode in the manner just described.

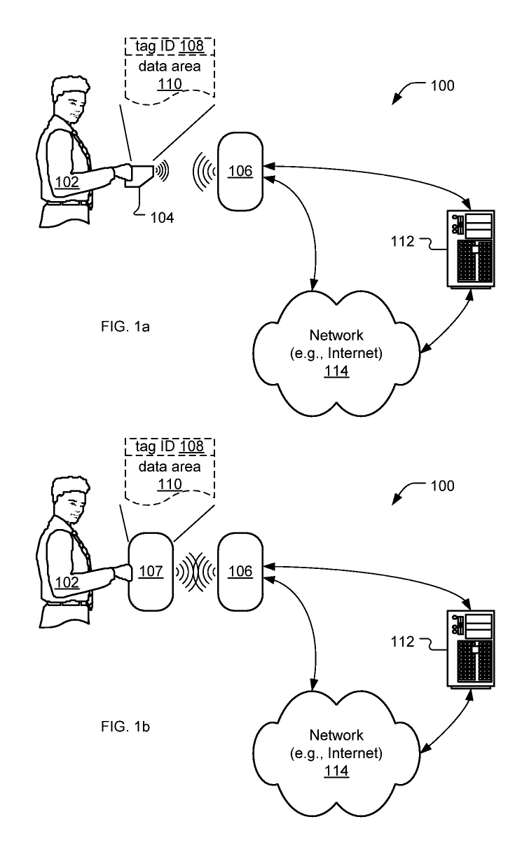

FIG. 1a-b are block diagrams depicting the major elements of an RFID security system 100 in accord with the present systems and methods. The present RFID security system 100 is employed by one or more users 102. Users 102 may, alternatively, be automated systems acting in place of people or even other automated systems. In FIG. 1a the users 102 primarily employ RFID tags 104 and RFID readers 106, and in FIG. 1b the users 102 primarily employ RFID devices 107 (i.e., RFID readers 106 used in place of RFID tags 104). In either case, the RFID tags 104, RFID readers 106, and RFID devices 107 can physically and electrically be essentially conventional devices.

The RFID tags 104 and RFID devices 107 each have a tag ID 108 and a data area 110, where some data values may already be stored or where additional data can be stored.

The RFID readers 106 and RFID devices 107 may be “dumb” terminal type devices, capable of merely reading or writing data to or from the RFID tags 104 and/or other RFID devices 107. Alternately, they can be “smart” systems, such as personal computers (PC), personal digital assistants (PDA), etc., that are suitably enhanced with RFID read/write capability. In the latter case, the intelligence of an RFID reader 106 or RFID devices 107 can be used for processing the data of the RFID tags 104 or RFID devices 107, or merely for communicating that data with another system that is performing such processing, e.g., a smart RFID reader can always be used as if it were merely a dumb RFID reader.

RFID security system 100 may optionally include one or more intermediary systems 112, and a network 114 may be used to communicate between multiple RFID readers 106 and intermediary systems 112, when such are employed. The network 114 can be a proprietary “hard-wired” network, a local or wide area network (LAN or WAN), a wireless network (WiFi), the Internet, or some combination of these.

RFID security system 100 can include as few as one RFID tag 104 and one RFID reader 106, or two RFID devices 107. Typically, however, the security system is used with multiple RFID tags 104, RFID readers 106, or multiple RFID devices 107. It is also expected that many embodiments will include multiple intermediary systems 112. FIG. 1a-b shows single instances of these elements.

To simplify the rest of the discussion herein, the terms RFID tag and RFID reader are used below, and it is to be understood that embodiments of the present RFID security system 100 may alternately employ RFID devices.

### Threshold Security and RFID

RFID tags provide a practical technology for handling the shares used in threshold cryptosystems. One or more RFID tags 104 storing shares can also be used as a sole share handling mechanism or with one or more other share handling mechanisms. Furthermore, a single RFID tag 104 can store one or more shares, thus permitting some shareholders to have greater weight than others.

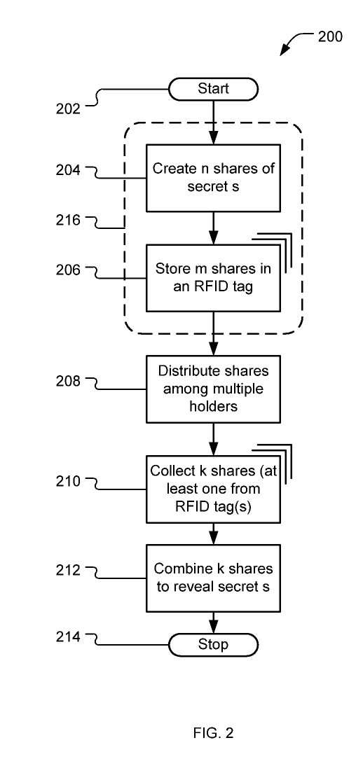

FIG. 2 is a flow chart depicting a threshold cryptography share handling process 200 in accord with the present systems and methods. In a step 202, the process 200 begins with secret data s that we wish to secure.

In a step 204, n shares of s are created, in an entirely conventional manner if desired. Optionally, as discussed below with some examples, additional data can be added to the created shares here.

In a step 206, some of the n shares are stored in an RFID tag. Frequently this will be just one share per RFID tag, but this is not a requirement, and there can be advantages in some embodiments of the present systems and methods to storing more than one share per RFID tag. For example, a quantity of shares stored in a RFID tag may be dependent on the RFID tag bearer's or shareholder's weight in a threshold cryptography scheme. Theoretically, all n shares can be stored in a single RFID tag. This capability is also discussed below with some examples.

FIG. 2 stylistically emphasizes that step 206 may be applied to multiple RFID tags, potentially storing different quantities of shares in each. This is expected to be the case for many embodiments of the present systems and methods, with all n shares stored across n or more different RFID tags in generally straightforward manner.

Continuing, in a step 208, the shares (i.e., the share handling mechanisms) can optionally be distributed to multiple holders. The holders can be people, locations, or both. This also is discussed below with some examples.

In a step 210, at least k shares are collected from the RFID tags that were created in step 206. Just as FIG. 2 stylistically emphasizes that step 206 may be applied to multiple RFID tags, step 210 similarly emphasizes that multiple RFID tags may have to be read to collect at least k shares. Again, it should be kept in mind that RFID tags are a preferred share handling mechanism but not necessarily an exclusive one. Accordingly, step 210 can be a simple or a quite complex operation. Some examples discussed below further illustrate this.

In a step 212, the k shares are combined to reveal the secret data s, and in a step 214 the process 200 is finished. A number of variations and subtleties in the process 200 are possible, and some representative examples are now discussed.

In FIG. 2 steps 204-206 comprise a stage 216 (shown in ghost outline). If the desired share handling comprises merely share storage, stage 216 is all that is needed and the process 200 is finished. For example, in this manner archival data can be stored that may never necessarily be distributed or reassembled.

An option in step 204 is to incorporate additional data with the shares as they are created. This additional data can be incorporated with only some of the shares, be the same for all of the shares, or be distinct for each of the shares. It can also be integrated into a share or be concatenated with a share. Of course, this is simply data, generically, and it can itself even optionally be further encrypted. Some examples of what such additional data can be used for are provided below with the discussion of examples for step 210.

An already noted option for step 206 is to store all n shares in a single RFID tag. Simply storing all of the shares together in one place may not seem particularly secure or useful, but it should be keep in mind that some or all of the shares can also be additionally processed, say, with additional encryption using a PKI or IBE scheme. Some potential applications here might be where secret data includes a relatively voluminous amount of data that is desirably secured in a single physical device or where secret data is a code that is desirably embodied into single physical device that multiple people can access by entering respective keys.

Another option in step 206 relates to lost shares. Since the shares are physically embodied in RFID tags, lost or damaged tags can quite easily be replaced for valid shareholders without compromising the secret data, or not replaced without compromising reassembly. Furthermore, the tangible nature of share bearing RFID tags can instill in shareholders the importance of protecting them as well as lead to easy and prompt observation when a RFID tag is lost or damaged. This is a marked advantage over files stored in a traditional media like a computer disk drive, where loss or corruption is not likely to be perceived until actual file use is attempted. Also, passive RFID tags do not require a battery, unlike many other electronic storage mechanisms, and are not human readable, such as archival documents are.

Distributing RFID tags bearing shares to holders that are people or to locations was introduced in step 208. For the sake of example, consider a very simple n=3, k=2 scheme. First, Alice, Bob, and Charles may each receive one of different RFID tags created in step 206. If Bob loses his tag, Alice and Charles can still retrieve the secret data. Second, Alice can receive all three tags and keep one in her office, one at her home, and one in a bank safe deposit box. In the unfortunate event her home is destroyed, she can still retrieve the secret data. Third, Alice can receive one key and Bob can receive two keys, one of which he keeps in his office and the other of which he keeps in a bank box. If Alice loses her key, Bob can get both of his keys and still retrieve the secret data.

Many options are possible in step 210. One category of these depends of whether additional data was incorporated with any of the shares in step 206. For instance, such additional data can be time constraints that specify when a share first will become active (i.e., it can be post-dated), how long it should remain active (i.e., it can be life-time limited), when it should become inactive (i.e., it can be expiration-dated), or combinations of these. Such constraints can specify absolute times or ones relative to when the additional data was incorporated with the share. If constraints are present, step 210 can act on them.

Furthermore, with multiple shares becoming available in step 210, it is possible to use quantity-of-collected shares and first- and last-collected shares as trigger events. For instance, additional data common to all of the shares can require that all the shares collected to reach the k share threshold must be read within 24 hours of an initial triggering quantity of shares being collected. Alternately, the additional data can require that all of the shares collected in step 210 must be read within one hour of the first. Or additional data in only the share issued to Charles may specify that it is only valid if one of Alice's or Bob's shares is the last one read.

Another category of options possible in step 210 relates to the action of reading RFID tags and the hardware-based nature of this. A single RFID reader may perform step 210 and step 212, reading the shares, acting on anything specified or requested in any additional data incorporated with them, and reconstructing and verifying the secret data. Alternately, multiple networked RFID readers can be used to collect the shares, with one receiving the shares from the others and then performing post-collection operations. Or multiple networked RFID readers can collect the shares and pass them on to one or more intermediary systems for the post-collection operations. Of course, as a matter of design choice, permitting the use of multiple networked RFID readers allows shareholders to be non-co-located, potentially anywhere if a global network such as the Internet is employed. Alternately, requiring the use of only one reader mandates that the shareholders be co-located to retrieve the secret data, s.

As noted in the Background Art section, threshold techniques have not been widely used due to logistical problems related to share handling. As can now be appreciated, however, the process 200 and hardware performing it can reduce or totally overcome these problems. When used in accord with the teaching herein, RFID tags 104 are highly suitable for share storage and transport and RFID readers 106 are highly suitable for share reassembly as well as many useful additional operations coincidental with reassembly.

### Identity-Based Encryption and RFID

RFID tags 104 also provide a practical technology for handling the keys used in identity-based encryption (IBE). The arbitrary string in an IBE cryptosystem can be the tag ID 108 (or any other arbitrary field) of an RFID tag 104 in the possession of a user 102. Additionally, the private key associated with the public key can be written to the same RFID tag 104 (or another associated one)(as long as it is suitably protected, e.g., in write-once storage, encrypted, and protected with a message authentication code (MAC) algorithm).

This approach is particularly novel because, when the RFID tag 104 is placed in the field of a RFID reader 106, the tag ID 108 is automatically read and is then immediately usable as a public key to encrypt data to be passed to the RFID tag 104 or to the holder of it. The RFID tag 104 or a holder of the private key can then decrypt the data at a later time.

This creates a very useful mechanism for securing the communication between the RFID tag 104 and the RFID reader 106 without requiring (1) a secure air protocol (e.g., MIFARE (TM)) or (2) complex key management on the RFID reader 106 or the RFID tag 104.

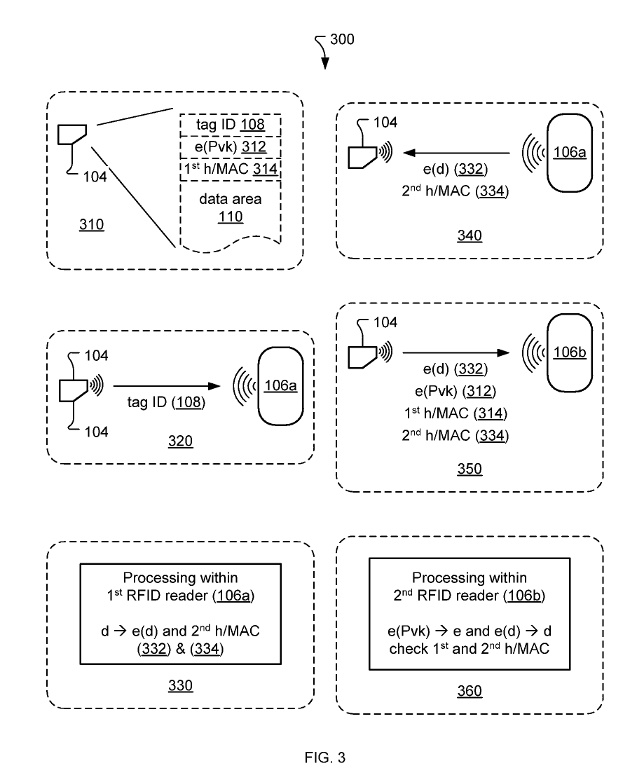

FIG. 3 is a schematic depicting an IBE cryptosystem scenario 300 that is in accord with the present systems and methods.

In a stage 310, scenario 300 begins with a RFID tag 104 being provided. In addition to its tag ID 108, the RFID tag 104 here already has an encrypted private key 312, e(Pvk); an optional first hash/MAC value 314 based on the value of the private key; and available capacity to store data, d in data area 110. The encrypted private key 312, e(Pvk), is associated with the tag ID 108 (in the manner described above). The particular manner of encryption used for the encrypted private key 312 is a matter of design choice.

In a stage 320, the RFID tag 104 enters the field of a first RFID reader 106a (i.e., that of a source RFID reader 106) which reads the tag ID 108.

In a stage 330, the first RFID reader 106a then uses the tag ID 108 as the basis for a public key to encrypt the data, d, thus creating encrypted data 332, e(d). Optionally, a second hash/MAC value 334 based on the data, d, can also be generated here for later use to perform integrity checks.

It should be noted that the encrypted private key 312, e(Pvk), and the encrypted data 332, e(d) will usually be encrypted using different algorithms, such that we have e₁(Pvk) and e₂(d) where the first algorithm, e₁, need not be the same as the second algorithm, e₂. However, the second algorithm, e₂, is by definition here one in an IBE cryptosystem.

In a stage 340, the first RFID reader 106a stores (writes) the encrypted data 332, e(d), on the RFID tag 104 (potentially along with the second hash/MAC value 334).

In a stage 350, the RFID tag 104 enters the field of a second RFID reader 106b (i.e., that of a destination RFID reader 106 that is potentially, but not necessarily, a different one than the first RFID reader 106a) which reads the encrypted data 332, e(d), as well as the encrypted private key 312, e(Pvk). If present, the second RFID reader 106b can also read the first hash/MAC value 314 and the second hash/MAC value 334.

In a stage 360, the second RFID reader 106b decrypts the encrypted private key 312, e(Pvk), to retrieve the private key, Pvk, and uses it to decrypt the encrypted data 332, e(d), to retrieve the data, d. Optionally, the first hash/MAC value 314 on Pvk and the second hash/MAC value 334 on d can now also be checked.

One variation of the scenario 300 includes the private key, Pvk, or the encrypted private key 312, e(Pvk), being made available to the second RFID reader 106b (or an intermediary system 112 that it communicates with) by other means than the RFID tag 104 that the encrypted data 332, e(d), is stored in. A further variation of this is for one of these to be on another RFID tag 104. Both variations accordingly allow the encrypted data and the private key to be transported to an end destination via different paths.

### Cloning Attacks and RFID

Cloning of an RFID tag 104 can be defeated by including a secure hash (e.g., SHA) or a digital signature (e.g., DSA) on the RFID tag 104. This requires pre- or post-provisioning (or other access to) the SHA key or X.509 certificate, but should not be unduly burdensome in most embodiments. Even if these measures are not taken, however, there are other inherent aspects of the present systems and methods that help maintain security.

In threshold encryption, copying of the data without the ability to decrypt it is not useful. The nature of threshold encryption makes it robust against exposure of n-k secrets. In using RFID tags 104 for secret data sharing, the usual expectation is that the ephemeral key value is placed on the RFID tag 104 by a first RFID reader 106a, carried to a second RFID reader 106b, and then read and erased in short order. There therefore is usually little opportunity for snooping cloning. Once a RFID tag 104 is provisioned, provisioning can be shut down, making a posterori attacks irrelevant.

In IBE cryptosystems the keying is constructed in such a way that simple cloning of a public tag ID 108 would not work to provide access to data. In any event, access to, or copying of, the public key is not a security issue in IBE cryptosystems.

While various embodiments have been described above, it should be understood that they have been presented by way of example only, and that the breadth and scope of the present system and methods should not be limited by any of the above described exemplary embodiments, but should instead be defined only in accordance with the following claims and their equivalents.

### INDUSTRIAL APPLICABILITY

The present RFID security system 100 is well suited for application in handling secret data. As has been discussed herein, the present systems and methods provide a general, transportable, and secure storage for the handling of secret data, including use for encryption or decryption, signing or verification, and performing integrity checks on such data or on other mechanisms used to secure such data. The present systems and methods also provide practical mechanisms for share handling in threshold cryptosystems and for employing identity-based encryption (IBE).

Presently available RFID tags and RFID readers, optionally with intermediary systems and a communication network, are adequate for implementing embodiments of the present systems and methods.

The above examples are merely representative ones in some sectors of industry than can benefit from the present systems and methods. Many other sectors of industry can also benefit from the present systems and methods.

1. A process for handling secret data, the process comprising:
(a) writing a cryptography key in a data storage area in a radio-frequency identification (RFID) tag while said RFID tag is associated with a first holder;
(b) reading said cryptography key from said RFID tag while said RFID tag is associated with a second holder; and
(c) performing at least one of the steps of encrypting, decrypting, signing, signature verifying, and integrity checking the secret data, wherein the steps are performed based on said cryptography key.

2. The process of claim 1, wherein said first holder and said second holder are different people or locations.

3. The process of claim 1, further comprising:
prior to step (a), encrypting said cryptography key; and
prior to step (c), decrypting said cryptography key.

4. The process of claim 1, wherein step (a) includes writing said cryptography key in said data storage area such that said cryptography key is read-only.

5. The process of claim 1, further comprising, after step (b), altering said RFID tag so that said cryptography key cannot be read again.

6. A process for handling secret data, the process comprising:
(a) creating n shares of the secret data using a threshold cryptography algorithm such that only reconstruction of at least k of said shares reveals the secret data and wherein 1<k≧n; and
(b) storing at least one said share in a radio-frequency identification (RFID) tag.

7. The process of claim 6, further comprising:
(c) collecting at least k of said shares, including reading at least one said share from a single said RFID tag; and
(d) combining said at least k of said shares to reveal the secret data.

8. The process of claim 7, wherein step (c) includes requiring that at least m said shares be read from said RFID tags with the same RFID reader, wherein m≦k.

9. The process of claim 7, wherein step (c) includes requiring that at least m said shares be read from said RFID tags in accordance with a time criteria triggered by one said RFID tag, wherein m≦k.

10. The process of claim 7, wherein step (c) includes altering at least one said RFID tag so that one or more shares stored on said at least one said RFID tag cannot be read again.

11. The process of claim 7, further comprising, after step (b), distributing said shares among multiple holders such that step (c) includes retrieving instances of said shares from at least two of said holders, wherein said holders are people or locations.

12. An RFID tag made by the process of claim 6.

13. A process for handling secret data, the process comprising:
(a) obtaining, in a radio-frequency identification (RFID) tag, an arbitrary value for an identity-based encryption (IBE) algorithm;
(b) reading said arbitrary value from said RFID tag; and
(c) determining a public key based on said arbitrary value, wherein said public key has a corresponding private key.

14. The process of claim 13, wherein step (a) includes selecting said arbitrary value to be that of a field already stored in said RFID tag.

15. The process of claim 13, wherein step (a) includes storing said arbitrary value in said RFID tag.

16. The process of claim 13, wherein step (a) includes pre-storing, in said RFID tag, an instance of said private key that has been encrypted.

17. The process of claim 16, wherein step (a) includes pre-storing, in said RFID tag, a first security value based on said private key and a hash or a message authentication code algorithm, thereby permitting said first security value to be read later and used to perform an integrity check on a decrypted instance of said private key.

18. The process of claim 13, further comprising storing an encrypted instance of said private key in said RFID tag.

19. The process of claim 18, further comprising storing, in said RFID tag, a first security value based on said private key and a hash or a message authentication code algorithm, thereby permitting said first security value to be read later and used to perform an integrity check on a decrypted instance of said private key.

20. The process of claim 13, further comprising:
(d) encrypting the secret data with said public key into encrypted data; and
(e) writing said encrypted data to said RFID tag.

21. The process of claim 20, further comprising:
prior to step (d), calculating a second security value based on the secret data using a hash or a message authentication code algorithm; and wherein
step (e) further includes writing said second security value into said RFID tag, thereby permitting said second security value to be read later and used to perform an integrity check on a decrypted instance of the secret data.

22. The process of claim 20, further comprising:
(f) reading said encrypted data from said RFID tag;
(g) obtaining an encrypted private key which is an instance of said private key that has been encrypted;
(h) decrypting said encrypted private key into said private key; and
(i) decrypting said encrypted data with said private key into the secret data.

23. The process of claim 22, wherein:
said (b) performs said reading of said arbitrary value at a first location; and
said (f) performs said reading of said encrypted data at a second location.

24. The process of claim 22, further comprising, after step (f), altering said RFID tag so that said encrypted data cannot be read again.

25. An RFID tag made by the process of claim 13.
